(19) United States
(12) Patent Application Publication
(10) Pub. No.: US 2001/0006442 A1
(43) Pub. Date: Jul. 5, 2001

(54) Flexible disk drive having a wiring guide for preventing short-circuiting

(76) Inventors: Hisateru Komatsu, Tendo-shi (JP); Mamoru Takahashi, Murayama-shi (JP)

Correspondence Address: FRISHAUF, HOLTZ, GOODMAN,, LANGER & CHICK, P.C., 25th Floor, 767 Third Avenue, New York, NY, 10017, US

(21) Appl. No.: 09/748,938

(22) Filed: Dec. 27, 2000

(30) Foreign Application Priority Data
Dec. 28, 1999 (JP) 374169/1999

(51) Int. Cl. G11B 17/02

(52) U.S. Cl. 360/99.04

(57) ABSTRACT

In a flexible disk drive, a guide member is used for guiding leads of a motor mounted on a main surface of the main frame to a circuit board attached to a back surface of the main frame. The main frame has a protrusion which protrudes into a side of the back surface and which has a top surface with an opening. The guide member comprises a first portion fixed to the top surface, a second portion fixed to between the circuit board and the main frame, and a third portion connecting the first portion with the second portion. The guide member is disposed between the main frame and the leads form the opening to the circuit board and prevent the leads from short-circuiting.

### BACKGROUND OF THE INVENTION

This invention relates to a flexible (or floppy) disk drive and, in particular, to a wiring structure of a flexible disk drive having a main frame which serves as a motor frame.

A conventional flexible disk drive comprises a main frame, a main printed circuit board, and a direct drive motor (or a spindle motor). The main printed circuit board and the direct drive motor are located on the side of a back surface of the main frame. The direct drive motor has a printed wiring board supported by a motor frame fixed to the back surface of the main frame. The main printed circuit board and the printed wiring board are connected each other by leads. In the conventional flexible disk drive, it is easy to connect the printed wiring board with the main printed circuit board. This is because the main printed circuit board and the printed wiring board can be arranged in close proximity to each other.

However, the conventional flexible disk drive has a problem that the flexible disk drive comprises a large number of parts and therefore requires a large number of assembling steps to assemble it. Moreover, the conventional flexible disk drive has another problem that operating characteristics of the direct drive motor depend on a state that the motor frame is attached to the main frame.

A flexible disk drive which does not have the above mentioned problems have been proposed by the present applicants. The proposed flexible disk drive comprises a main frame and a direct drive motor disposed on a main surface of the main frame. The main frame serves as a motor frame. The flexible disk drive does not have a printed wiring board for the direct drive motor on the side of a back surface of the main frame. Thus, the number of parts of the proposed flexible disk drive is smaller than that of the conventional flexible disk drive.

By the way, a main printed circuit board of the proposed flexible disk drive is located on the side of the back surface of the main frame to meet the demand for miniaturization. Accordingly, it is necessary to form an opening window (or a through hole) in the main frame to connect leads of the direct drive motor to the main printed circuit board. The leads are drawn out from the side of the main surface to the rear side through the opening window.

In this structure, the leads may possibly touch an edge of the opening window and/or one another so that coatings formed thereon are scraped off by the edge of the opening window and/or by one another. The leads from which the coatings are partially scraped off are easy to short-circuit. Moreover, the leads may possibly be connected to wrong terminals of the main printed circuit board because the direct drive motor is distant from the main printed circuit board.

### SUMMARY OF THE INVENTION

It is therefore an object of this invention to provide a flexible disk drive which can prevent leads of a direct drive motor from short-circuiting.

It is another object of this invention to provide a flexible disk drive which is free from the possibility of wrong connection of leads of a direct drive.

It is still another object of this invention to provide a wiring structure which uses a wiring guide for guiding leads of a direct drive motor to a main printed circuit board in a flexible disk drive.

Other object of this invention will become clear as the description proceeds.

According to a first aspect of this invention, a flexible disk drive includes a main frame having a main surface, a back surface, and an opening formed therein, a motor having a plurality of leads and mounted on the main surface, and a circuit board attached to the back surface. The leads are connected to the circuit board through the opening. The flexible disk drive further comprises a guide member which is disposed between the main frame and the leads to extend from the opening to the circuit board so as to prevent said leads from touching said main frame.

According to a second aspect of this invention, a wiring structure is for arranging a plurality of leads from a first surface of a first member to a second surface of a second member having a third surface reverse to said second surface. The first surface and the second surface are substantially parallel to each other in a predetermined direction perpendicular to the first and the second surfaces and are arranged at different heights to form steps. The wiring structure comprises a guide member having a first portion fixed to the first surface, a second portion fixed to the third surface, and a third portion connecting the first portion with the second portion. The guide member guides the leads.

According to a third aspect of this invention, a guide member is for guiding a plurality of leads from a first surface of a first member to a second surface of a second member having a third surface reverse to said second surface. The first surface and the second surface are substantially parallel to each other in a predetermined direction perpendicular to the first and the second surfaces and are arranged at different heights to form steps. The guide member comprises a first portion fixed to said first surface, a second portion fixed to said third surface, and a third portion connecting said first portion with said second portion.

### BRIEF DESCRIPTION OF THE DRAWING

FIG. 1 is an exploded perspective view showing a main part of a conventional flexible disk drive;

FIG. 2 is a schematic perspective view of the flexible disk drive illustrated in FIG. 1;

FIG. 3 is a sectional view showing a relationship between a main frame and a direct drive motor mounted thereon in the flexible disk drive illustrated in FIG. 1;

FIG. 4 is a plan view for use in describing a structure of a stator in the direct drive motor illustrated in FIG. 3;

FIG. 5 is a view of a main frame for use in a flexible disk drive according to a preferred embodiment of this invention as seen from an obliquely upper front side;

FIG. 6 is a schematic perspective view of the main frame illustrated in FIG. 5 as seen from an obliquely upper lateral side;

FIG. 7 is a schematic perspective view of the main frame illustrated in FIGS. 5 and 6 as seen from an obliquely lower lateral side;

FIG. 8 is a schematic perspective view of a state where a main printed circuit board is mounted on the main frame illustrated in FIGS. 5 to 7 as seen from the obliquely lower lateral side;

FIG. 9A is a plan view of a guide member for use in the flexible disk drive of the preferred embodiment;

FIG. 9B is a bottom view of the guide member illustrated in FIG. 9A;

FIG. 9C is a left-hand side view of the guide member illustrated in FIG. 9A;

FIG. 9D is a right-hand side view of the guide member illustrated in FIG. 9A;

FIG. 9E is a front view of the guide member illustrated in FIG. 9A;

FIG. 9F is a sectional view taken along a line A-A in FIG. 9A;

FIG. 10 is a schematic perspective view of a state where the guide member of FIGS. 9A to 9F is attached to the main frame of FIGS. 5 to 7;

FIG. 11 is a schematic perspective view of a state where the main printed circuit board is mounted on the main frame to which the guide member is attached;

FIG. 12 is a schematic perspective view of a state where leads are hooked at hooks of the guide member; and

FIG. 13 is a schematic perspective view of another guide member for use in the flexible disk drive of this invention.

### DESCRIPTION OF THE PREFERRED EMBODIMENT

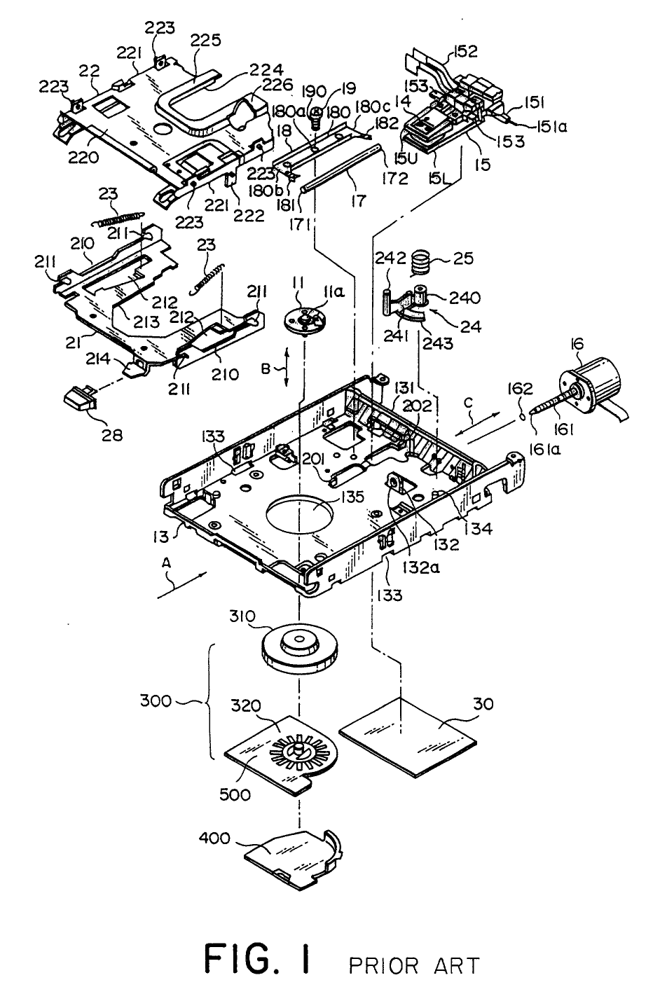

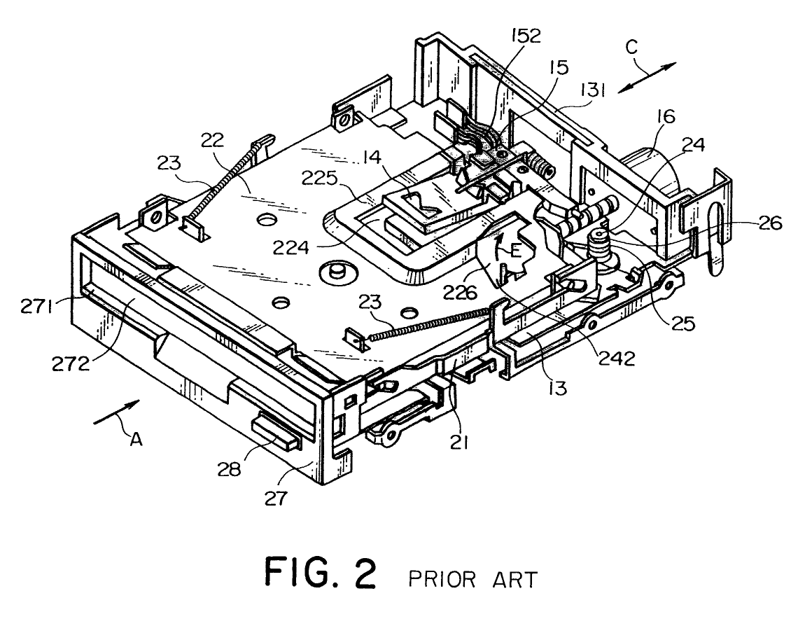

Referring to FIGS. 1 and 2, description will at first be directed to a conventional flexible disk drive for a better understanding of this invention. FIG. 1 is an exploded perspective view of the conventional flexible disk drive of a 3.5-inch type. Though the conventional flexible disk drive has a front panel and a case, they are omitted in FIG. 1. FIG. 2 is a schematic perspective view of the conventional flexible disk drive in assembled state. The case is omitted in FIG. 2.

The illustrated flexible disk drive is a device for driving a flexible (or floppy) disk (not shown) of a 3.5-inch type. The floppy disk is loaded in the flexible disk drive from a direction indicated by an arrow A in FIGS. 1 and 2. The loaded floppy disk is held on a disk table 11 having a rotation axis 11a. In this event, the rotation axis 11a coincides with a center axis of the floppy disk. As mentioned later, the disk table 11 is rotatably supported on a main surface of the main frame 13. Accordingly, the rotation axis 11a of the disk table 11 has an axial direction B which extends in parallel with a thickness direction of the main frame 13. The disk table 11 is rotatably driven by a direct drive (or spindle) motor 300, which is mounted on a back surface of the main frame 13, whereby a magnetic recording medium of the flexible disk rotates. In addition, on the back surface of the main frame 13 is attached a main printed circuit board 30 on which a number of electronic parts (not shown) are mounted.

The flexible disk drive comprises a pair of upper and lower magnetic heads 14 (only the upper magnetic head is illustrated) for reading/writing data from/to the magnetic recording medium of the floppy disk. The magnetic heads 14 are supported in a carriage assembly 15 at a tip thereof that is laid in the flexible disk drive on the rear side. That is, the carriage assembly 15 comprises an upper carriage 15U for supporting the upper magnetic head 14 and a lower carriage 15L for supporting the lower magnetic head. The carriage assembly 15 is disposed over the main surface of the main frame 13 and is apart from the main frame 13 in the manner which will later be described. The carriage assembly 15 supports the magnetic heads 14 movably along a predetermined radial direction (i.e. a direction indicated by an arrow C in FIGS. 1 and 2) to the flexible disk.

In addition, the main frame 13 has on the rear side a side wall 131 on which a stepping motor 16 is fixed. The stepping motor 16 linearly drives the carriage assembly 15 along the predetermined radial direction C. More specifically, the stepping motor 16 has an axis of rotation (a driving shaft) 161 which extends in parallel with the predetermined radial direction C and which is threaded to form a male screw. The driving shaft 161 has a tip 161a which penetrates a hole 132a bored in a bent piece 132 and which is provided with a steel ball 162. The bent piece 132 is raised from the main surface of the main frame 13 by cutting and bending. With the hole 132a and the steel ball 162, a position of the driving shaft 161 is defined so as to extend in parallel with the predetermined radial direction C and the tip 161a is rotatably held.

On the other hand, the carriage assembly 15 comprises an arm 151 which extends from the lower carriage 15L to the driving shaft 161. The arm 151 has a leading edge 151a which is bent so as engage with the root in the male screw of the driving shaft 161. Therefore, when the driving shaft 161 of the stepping motor 16 rotates, the leading edge 151a of the arm 151 moves along the root in the male screw of the driving shaft 161, thereby the carriage assembly 15 moves along the predetermined radial direction C. At any rate, the stepping motor 16 serves as a driving arrangement for linearly moving the carriage assembly 15 along the predetermined radial direction C.

Inasmuch as the driving shaft 161 of the stepping motor 16 is disposed on one side of the carriage assembly 15, the one side of the carriage assembly 15 is movably supported by the driving shaft 161 and is apart from the main surface of the main frame 13. However, because support occurs by the driving shaft 161, it is difficult to dispose the whole of the carriage assembly 15 apart from the main surface of the main frame 13. That is why a guide bar 17 supports and guides the carriage assembly 15 on another side thereof. The guide bar 17 is opposite to the driving shaft 161 of the stepping motor 16 with the carriage assembly 15 inserted between the guide bar 17 and the driving shaft 161. The guide bar 17 extends in parallel with the predetermined radial direction C and has one end 171 and another end 172 which are mounted on the main surface of the main frame 13 in the manner which later be described. The guide bar 17 guides the carriage assembly 15 along the predetermined radial direction C. As a result, the whole of the carriage assembly 15 is disposed apart from the main surface of the main frame 13.

In addition, a flexible printed circuit (FPC) 152 extends from the carriage assembly 15 to the vicinity of the guide bar 17 and is electrically connected to the main printed substrate attached to the back surface of the main frame 13.

The guide bar 17 is clamped on the main surface of the main frame 13 by a guide bar clamp 18. The guide bar clamp 18 is fixed on the main surface of the main frame 13 at a center portion thereof by a binding small screw 19. More specifically, the guide bar clamp 18 comprises a rectangular fixed member 180 having a length longer than that of the guide bar 17 by a short distance. In about the center of the rectangular fixed member 180, a hole 180a is drilled through which a screw shaft 190 of the binding small screw 19 passes. The rectangular fixed member 180 has one end 180b and another end 180c from which a pair of arms 181 and 182 extend to clamp the one end 171 and the other end 172 of the guide bar 17 which is sandwiched between the arms 181 and 182, respectively.

Inasmuch as the guide bar clamp 18 merely clamps the guide bar 17, the guide bar 17 is not mounted on the main surface of the main frame 13 by the guide bar clamp 18 alone. This is why a pair of locating members for locating the both ends 171 and 172 of the guide bar 17 is needed. As the pair of locating members, a pair of bent pieces 201 and 202 is used which are formed by cutting and bending parts of the main frame 13. At any rate, the pair of bent pieces 201 and 202 locates both ends 171 and 172 of the guide bar 17 to mount the guide bar 17 on the main surface of the main frame 13 in cooperation with the guide bar clamp 18.

The lower carriage 15L of the carriage assembly 15 serves as a supporting frame for supporting the carriage assembly 15 slidably along the guide bar 17. The lower carriage 15L has a projecting portion (not shown) which projects into the main surface of the main frame 13 on the side of the guide bar 17. The guide bar 17 is slidably fitted in the projection portion.

The flexible disk drive further comprises an eject plate 21 and a disk holder 22. Each of the main frame 13, the eject plate 21, and the disk holder 22 is formed by performing stamping out, press working, and bending of a metal plate.

The eject plate 21 is mounted on the main surface of the main frame 13 slidably along the insertion direction A of the floppy disk and an opposite direction. In the manner which will later become clear, the eject plate 21 holds, in cooperation with the disk holder 22, the floppy disk in operation of the flexible disk drive. In addition, the eject plate 21 holds the floppy disk slidably along in the insertion direction A so as to allow the flexible disk drive to load the floppy disk therein along the insertion direction A and to allow the floppy disk drive to eject the floppy disk therefrom along the opposite direction. The eject plate 21 comprises a pair of side walls 210 which are opposite to each other. Each of the side walls 210 has a pair of cam portions 211. In addition, the eject plate 21 has a bottom surface on which cut portions 212 are formed along the both side walls 210 and a U-shaped cut portion 213 is formed at a center portion thereof so as to enclose the disk table 11. Furthermore, the eject plate 21 has a back surface on which a pin (not shown) is provided. The pin engages with a stop part of an eject lever which will later be described.

The disk holder 22 is disposed on the eject plate 21. The disk holder 22 comprises a principal surface 220 and a pair of side walls 221 which is formed at both side ends of the principal surface 220 to opposed to each other. The both side walls 221 have projection pieces 222 (only one is illustrated). The projection pieces 222 are inserted in bores 133 of the main frame 13 through the cut portions 212 of the eject plate 21. Inasmuch as the projection pieces 222 are inserted in the bores 133 of the main frame 13, the disk holder 22 is positioned against the main frame 13 in the insertion direction A and the disk holder 22 is allowed to reciprocate in the axial direction B of the rotation axis 11a of the disk table 11. Each of the both side walls 221 has a pair of pins 223. The pins 223 are inserted in the cam portions 211 formed in the side walls 210 of the eject plate 21. Between the disk holder 22 and the eject plate 21, eject springs 23 is bridged.

Although the disk holder 22 may be provided with the projection pieces 222 and the bores 133 are formed in the main frame 13 in the above-mentioned embodiment, restriction is not made to this structure and the main frame 13 may be provided with projection pieces and bores may be formed in the disk holder 22.

In addition, the disk holder 22 has a rectangular opening section 224 at a center portion on the back side in the insertion direction A. The rectangular opening section 224 is laid in a corresponding position of the upper carriage 15U of the carriage assembly 15 and extends in the predetermined radial direction C. So as to enclose the opening section 224, a U-shaped swelled portion 225 is formed where the principal surface 220 of the disk holder 22 swells at periphery upwards. On the other hand, the carriage assembly 15 comprises a pair of side arms 153 which extends in a lateral direction perpendicular to a longitudinal direction of the carriage assembly 15. The side arms 153 are located on or over the swelled portion 225. As will later be described, in a state where the floppy disk is ejected from the disk holder 22, the side arms 153 engages with the swelled portion 225, thereby the pair of upper and lower magnetic heads 14 are apart from each other. In addition, the disk holder 22 has an additional opening section 226 on the right-hand side of the opening section 224 on the back side of the insertion direction A. The opening section 226 has a shape so as to allow a lever part of the eject lever (which will later be described) rotatably move.

In the vicinity of the carriage assembly 15 on the main frame 13, the eject lever 24 is disposed so as to rotatably move. More specifically, on the main frame 13, a rod pin 134 is raised so as to extend from the main surface of the main frame 13 upwards. The eject lever 24 comprises a hollow cylindrical part 240 in which the rod pin 134 is inserted, an arm part (the lever part) 241 extending from the hollow cylindrical part 240 in a radial direction, a projection part 242 which is formed at a free end of the arm part 241 and which extends upwards, and an arc-shaped stop part 243 which extends from the side of the free end of the arm part 241 in a circumferential direction. In the eject lever 24, an eject lever spring 25 is attached around the hollow cylindrical part 240 and the eject lever spring 25 urges the eject lever 24 in a counterclockwise direction (i.e. in the direction reverse to an arrow E of FIG. 2) on a paper of FIG. 2. The projection part 242 of the eject lever 24 is freely fitted in the opening section 226 of the disk holder 22. The projection part 242 is engaged with a predetermined portion of a shutter of the floppy disk to control opening and shutting of the shutter. In addition, as shown in FIG. 2, a screw 26 is screwed into a tip of the rod pin 134 (see FIG. 1), thereby preventing the eject lever 24 from falling off the rod pin 134.

In addition, the main frame 13 has a front end section on which a front panel 27 is attached. The front panel 27 has an opening 271 for taking the floppy disk in and out and a door 272 for opening and shutting the opening 271. Through the front panel 27, an eject button 28 projects movably backward and forward. The eject button 28 is fitted in a protrusion part 214 which protrudes from a front end of the eject plate 21 forwards.

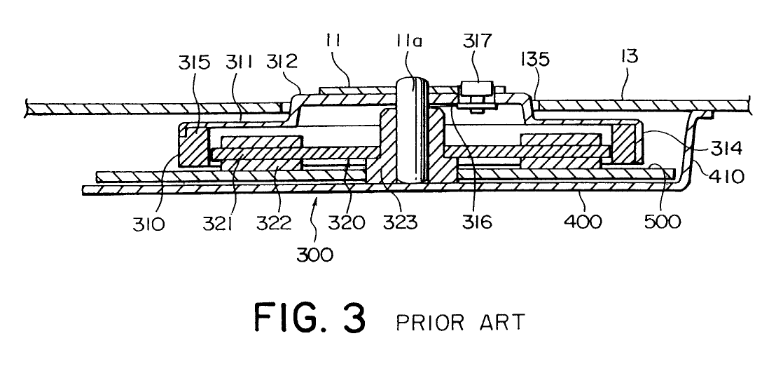

Referring to FIG. 3, a description will be made about the direct drive motor 300 which is used in the flexible disk drive.

The illustrated direct drive motor 300 comprises a rotor 310 and a stator 320 combined with the rotor 310. The rotor 310 has a disk-shaped metallic casing 311. The casing 311 has a protruding portion 312 formed at its center to protrude upward. The protruding portion 312 has an upper surface to which a disk table 11 is mounted. The main frame 13 has a circular opening 135 which allows only an upper part of the protruding portion 312 to pass therethrough and to project on the principal surface. Thus, the disk table 11 is projected on the main surface of the main frame 13.

The rotor 310 has a metallic rotation shaft 11a which is integrally fixed to the rotor 310 at the center thereof to pass through the casing 311 and the disk table 11. The casing 311 and the rotation shaft 11a are integrally assembled when the disk table 11 is injection-molded by the use of a plastic magnet. The casing 311 has a hollow cylindrical member 314 formed on its outer periphery to extend downward. A ring-shaped permanent magnet 315 is attached to an inner surface of the hollow cylindrical member 314.

The permanent magnet 315 has a plurality of main magnetized elements along a circumferential direction thereof. In addition, the permanent magnet 315 has a bottom portion which has a plurality of motor-servo magnetized elements along a circumferential direction thereof. When the stator 320 has fifteen poles (which will be later mentioned), the main magnetized elements are equal in number to twenty (that is, north poles are equal in number to ten and south poles are equal in number to ten). On the other hand, the motor-servo magnetized elements are equal to one hundred and twenty (that is, north poles are equal in number to sixty and south poles are equal in number to sixty) independently of the number of the poles of the stator 320. On the other hand, the motor-servo magnetized elements are equal to one hundred and twenty (that is, north poles are equal in number to sixty and south poles are equal in number to sixty) independently of the number of the poles of the stator 320. On the other hand, the motor-servo magnetized portion has one hundred twenty poles (i.e. sixty N poles and sixty S poles) regardless of the number of the poles of the stator 320. The main magnetized elements are called driving magnetized portions while the motor-servo magnetized elements are called detection magnetized portions.

In addition, as shown in FIG. 3, the hollow cylindrical member 314 has a cut portion from which a part of the main magnetized elements protrudes and is exposed as a magnetic pole.

The protruding portion 312 is provided with an arm 316 attached to a bottom surface thereof. A drive roller 317 is rotatably mounted on the arm 316. Each of the protruding portion 312 and the disk table 11 has a generally rectangular hole formed therein. Through these holes, the drive roller 317 projects upward from the disk table 11. The floppy disk received in the flexible disk drive is placed on the disk table 11. The drive roller 317 is inserted in and engaged with a hole (not shown) formed in a hub (not shown) of the floppy disk. Thus, the magnetic recording medium is rotated following the rotation of the rotor 310.

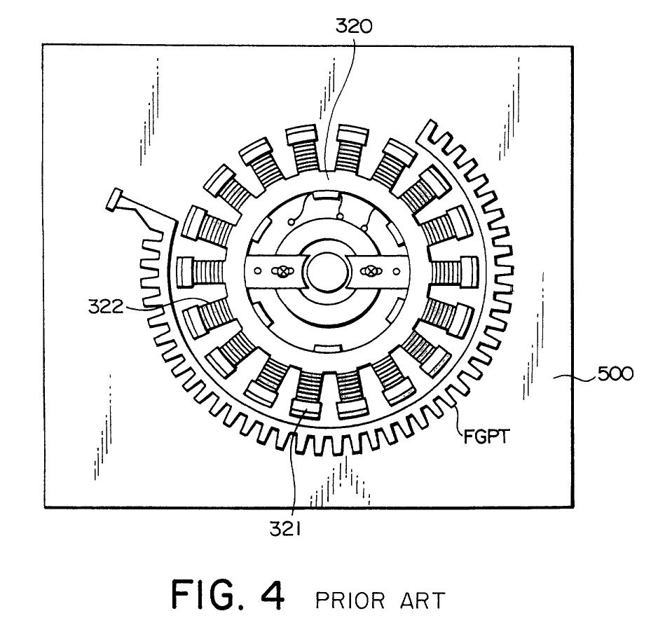

On the other hand, the stator 320 is attached to a back surface of the main frame 13 by using a motor frame 400 made of metal. More specifically, the stator 320 is formed on a printed wiring board 500 mounted on the principal surface of the metallic motor frame 400. As described in conjunction with FIGS. 3 and 4, the stator 320 comprises a core assembly having a plurality of stator cores 321, a plurality of stator coils 322, and a bearing unit (or a center metal) 323. Each of the stator cores 321 extends radially outwardly from an outer periphery of a ring-shaped member made of metal. Each of the stator coils 322 is wound around an end portion of each corresponding core 321. The bearing unit 323 is formed at the center of the printed wiring board 500 and rotatably supports the rotation shaft 11 a. The motor frame 400 has a plurality of attaching elements 410 of an inverted-L shape which extend upward from a peripheral edge of the motor frame 400 so as to abut against the back surface of the main frame 13.

As shown in FIG. 4, on the printed wiring board 500, a frequency generation pattern (FGPT) is formed around the stator 320. In other words, the frequency generation pattern FGPT is arranged to oppose to the motorservo magnetized elements (detection magnetized portions) of the permanent magnet 315 (see FIG. 3) so that a predetermined gap is formed distance left therebetween. In additon, FIG. 4 illustrates a case where the stator 320 has eighteen poles. That is, the stator cores 321 (or the stator coils 322) are equal in number to eighteen. In this case, the rotor 310 has the main magnetized elements which are equal in number to twenty-four. In this connection, as descried above, when the stator 320 has fifteen poles, the rotor 310 has the main magnetized elements which are equal to twenty.

When the motor-servo magnetized elements of the permanent magnet 315 rotate over the frequency generation pattern FGPT, a counter electromotive force generates in the frequency generation pattern FGPT. Inasmuch as the motor-servo magnetized elements of the permanent magnet 315 are equal in number to one hundred and twenty for a round, a signal of sixty cycles generates from the frequency generation pattern FGPT when the direct drive motor makes one rotation. This signal is called an FG servo signal. When the number of revolutions of the direct drive motor is equal to 300 RPM, the direct drive motor makes five rotations per second. In this event, the FG servo signal has a frequency of (60×5) or 300 Hz.

Accordingly, it is possible to control the rotation speed of the direct drive motor by comparing the FG servo signal with a divided clock signal having a divided clock frequency of 300 Hz which is obtained by frequency dividing a reference clock signal having a reference clock frequency of 1 MHz by using a counter. In other words, a speed control of the DD motor is carried out by starting the counter in synchronism with a leading edge timing of the FG servo signal and by comparing a trailing edge timing of the FG servo signal with a trailing edge timing of the divided clock signal which is obtained by counting a fixed value in the counter. More specifically, if the trailing edge timing of the FG serve signal is earlier than the trailing edge timing of the divided clock signal, the direct drive motor is controlled so as to decelerate the rotation speed of the direct drive motor. Conversely, if the trailing edge timing of the FG serve signal is later than the trailing edge timing of the divided clock signal, the direct drive motor is controlled so as to accelerate the rotation speed of the direct drive motor.

As described above, the conventional flexible disk drive comprises the printed wiring board 500 for forming the direct drive motor. In addition, the conventional flexible disk drive further comprises the motor frame 400 made of metal like the main frame 13 to support the printed wiring board on the side of the back surface of the main frame 13. In the conventional flexible disk drive, it is easy to electrically connect the printed wiring board 500 with the main printed circuit board 30 if the printed wiring board 500 and the main printed circuit board 30 are arranged adjacent to each other.

Thus, the conventional flexible disk drive comprises the motor frame 400 different form the main frame 13 and the print wiring board 500 located on the motor frame 400 and having the frequency generation pattern FGPT. Accordingly, the conventional flexible disk drive is a disadvantage in that it comprises a large number of parts and that a large number processes are necessary to assemble it.

In addition, the conventional flexible disk drive has a disadvantage that a stable operation state of the direct drive motor is difficult to obtain because operating characteristics of the direct drive motor depends on an attaching state of the motor frame to the main frame.

A previous flexible disk drive proposed by the applicants does not have the above-mentioned disadvantage. The previous flexible disk drive comprises a main frame serving as a motor frame and a direct drive motor disposed on a main surface of the main frame. The direct drive motor does not have a printed wiring board to be miniaturized.

Thus, the previous flexible disk drive does not have the printed wiring board and an independent motor frame independent of the main frame. Accordingly, the number of the parts of the previous flexible disk drive is smaller than that of the conventional flexible disk drive. Moreover, the number of the steps required for assembling the previous flexible disk drive is smaller than that required for assembling the conventional flexible disk drive. Furthermore, the direct drive motor of the previous flexible disk drive has uniform operation characteristics and is stable in operation because it is not disposed on independent motor frame but on the main surface of the main frame.

By the way, the previous flexible disk drive further comprises a main printed circuit board. Although the direct drive motor is disposed on the main surface of the main frame, the main printed circuit board is located on the side of the back surface of the main frame like the conventional flexible disk drive to meet the demand for miniaturization. Accordingly, it is necessary to form an opening window or a through hole in the main frame to connect leads of the direct drive motor to the main printed circuit board. The leads are drawn out from the side of the main surface to the rear side through the opening window and are connected to corresponding terminals formed on the main printed circuit board, respectively.

In this structure, coatings of the leads may possibly be scraped off by touching of the leads with edges of the opening window and/or with one another. The leads from which the coatings are partially scraped off are easy to short-circuit. Moreover, the leads may often be connected to wrong terminals of the main printed circuit board because the direct drive motor is distant from the main printed circuit board and the leads are long.

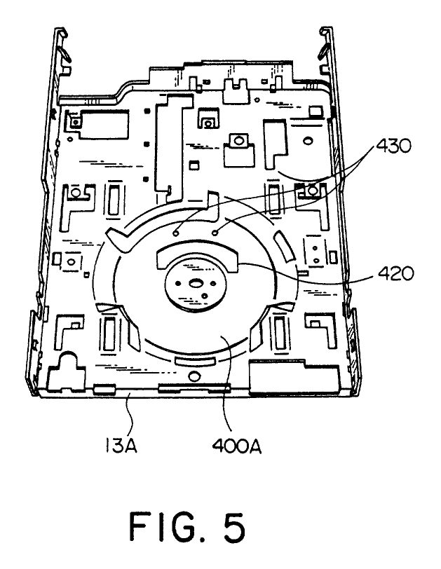

Referring to FIGS. 5 through 13, description will proceed to a flexible disk drive according to a preferred embodiment of this invention. Similar parts are designated by like reference numerals.

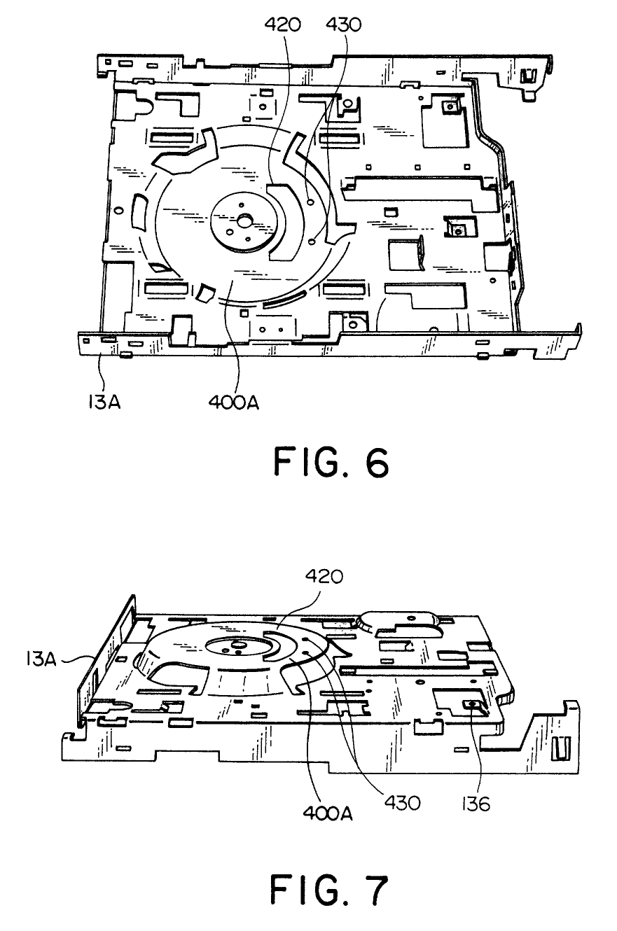

At first referring to FIGS. 5 to 7, description will be made about a main frame (or a frame structure) 13A used in the flexible disk drive according to the preferred embodiment. FIG. 5 is a schematic perspective view of the main frame 13A as seen from an obliquely upper front side. FIG. 6 is a schematic perspective view of the main frame 13A as seen from an obliquely upper lateral side. FIG. 7 is a schematic perspective view of the main frame 13A as seen from an obliquely lower lateral side.

As easily understood from FIGS. 5 to 7, the main frame 13A comprises a main frame part 13A in which the floppy disk (not shown) is inserted and a protruding area as a motor frame part 400A on which a direct drive motor (not shown), different in structure from the direct drive motor 300, for rotating the floppy disk inserted in the main frame 13A is mounted. That is, the main frame part and the motor frame part 400A are formed in a one-piece component and the main frame 13A serves both as an original main frame (i.e. the main frame 13 of FIG. 1) and an original motor frame (i.e. the motor frame 400 of FIG. 1).

The motor frame part 400A has a drawn shape formed by a drawing process. That is, as shown in FIG. 7, the motor frame part 400A protrudes into the back side of the main frame 13A to form a top surface which is a part of the back surface of the main frame 13A. In the top surface of the motor frame part 400A, an opening window 420 for drawing out the leads of the direct drive motor and a pair of through holes 430 for fixing a guide member (which will be later described) are formed.

Although the drawn shape of the motor frame part 400A illustrated in FIGS. 5 through 7 is a part of a conical shape and the top surface has a round shape, these shapes may be replaced by any other appropriate shapes. For example, the top surface may have an elliptical shape or a polygonal shape. In addition, the shape and the inclination of a side surface (inclined surface in the illustrated example) of the motor frame part 400A are not limited to that illustrated in FIGS. 5 to 7. Furthermore, shapes and the number of openings formed in the side surface of the motor frame 400A are not limited to those illustrated in FIGS. 5 to 7.

The flexible disk drive can adopt the main frame 13A having the above mentioned shape because the flexible disk drive does not have the frequency generation pattern FGPT (FIG. 4) and the printed wiring board 500 which are necessary to control the direct drive motor 300. Moreover, the motor-servo magnetized members formed at the bottom portion of the permanent magnet 315 of the rotor 310 are unnecessary because the flexible disk drive does not have the frequency generation pattern FGPT. Instead, the flexible disk drive comprises an electric processing unit which functions as the combination of the frequency generation pattern FGPT and the motor-servo magnetized members. Because the electric processing unit only indirectly relates to this invention, the description thereof is omitted herein.

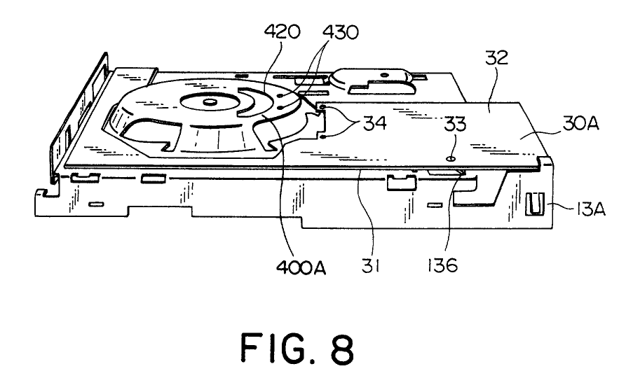

Referring to FIG. 8, the flexible disk drive comprises a main printed circuit board 30A which is attached to the back surface of the main frame 13A like the conventional flexible disk drive. The main printed circuit board 30A has a shape such as to avoid overlapping with the motor frame section 400A. The main frame 13A has a supporting (or receiving) piece 136 which is raised from the back surface of the main frame 13A by cutting and bending and which has a threaded hole formed in its tip portion. The main printed circuit board 30A is fixed to the supporting piece 136 by a screw 33 engaged with the threaded hole so that a main surface 31 of the main printed circuit board 30A is spaced at a predetermined distance from the back surface of the main frame 13A and that a back surface 32 of the main printed circuit board 30A is nearer to the back surface of the main printed circuit board 30A than the top surface of the motor frame part 400A. The top surface and the back surface of the main printed circuit board 30A are substantially parallel to each other in a predetermined direction perpendicular to the top and the back surfaces and are arranged at different heights to form steps..

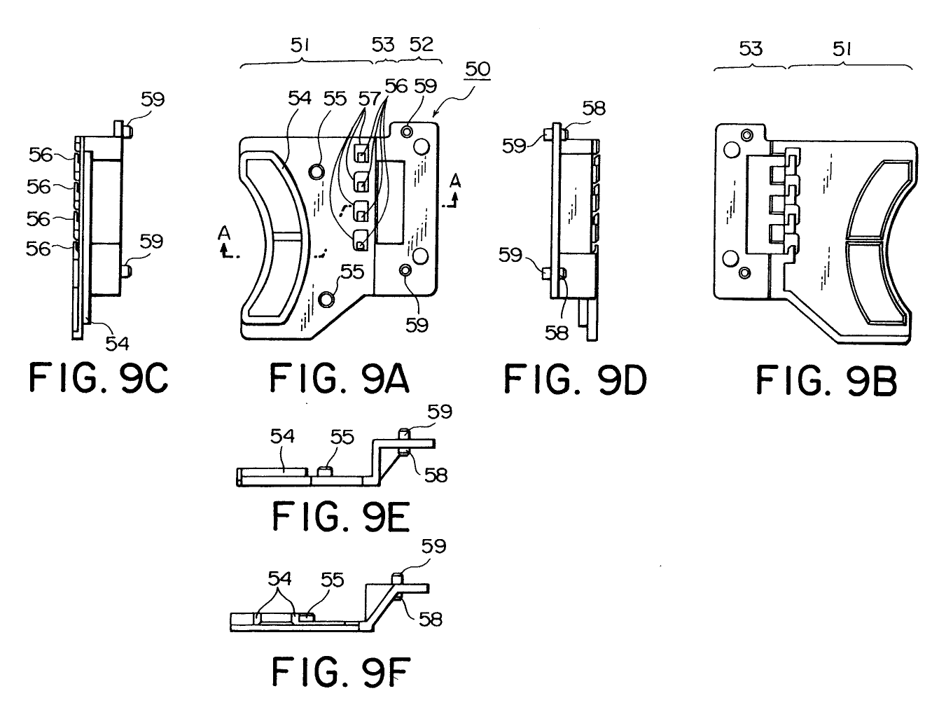

End portions (i.e. leads) of rotor coils wound around stator cores of the direct drive motor mounted on the motor frame part 400A on the side of the main surface of the main frame 13A are drawn out to the back side of the main frame 13A through the opening window 420 formed in the main frame 13A and connected to predetermined terminals on the main printed circuit board 30A. Generally, the leads are equal in number to four. Three of the leads correspond to U, V and W phases of three phase alternating current. The remaining one of the leads is connected to the other ends of the leads for the U, V and W phases. The flexible disk drive of this embodiment further comprises a guide member 50 illustrated in FIGS. 9A through 9F to guide the leads.

The guide member 50 is made of an insulator (e.g. insulating resin) and has a first part 51 to be attached to the main frame 13A, a second part 52 to be attached to the main print circuit board 30A, and a third part for connecting the first part 51 to the second part 52 as shown in FIGS. 5A through 5F.

The first part 51 has a first contact surface which comes into contact with the main frame 13A and on which a protruding frame 54 and engaging pins 55 are formed at the positions corresponding to the opening window 420 and the through holes 430, respectively. The protruding frame 54 and the engaging pins 55 are fitted into the opening window 420 and the through holes 430, respectively, when the guide member 50 is attached to the main frame 13A. The first part 51 further has the reverse side on which hooks 56 are formed to hook or hitch the leads. In the first part 51, pits 57 are formed at points corresponding to the hooks 56.

The second part 52 has a second contact surface which comes into contact with the main printed circuit board 30A and which faces in an opposite direction opposite to that of the first contact surface. The second contact surface has engaging pins 58 which is engaged with through holes 34 (FIG. 8) formed in the main printed circuit board 30A when the guide member 50 is attached to the main printed circuit board 30A.

Additionally, each of the through holes 34 has an inside diameter much smaller than that of each threaded hole for fixing the main printed circuit board 30A to the main frame 13A. The inside diameter of each through hole 34 is, for example, equal to about a half of the inside diameter of the threaded hole. In addition, small props 59 are formed on the reverse side of the second part 52 to support the main printed circuit board 30A against the main frame 13A.

Because the guide member 50 fixes the main printed circuit board 30A to the main frame 13A, fixing screws for fixing the main printed circuit board 30A to the main frame 13A can be smaller in number than that of the conventional flexible disk drive. That is, threaded holes, which are formed in the main printed circuit board 30A to pass the fixing screws, and supporting pieces, which are formed on the main frame 13A by cutting and bending of the main frame 13A to receive the fixing screws, can be smaller in number than those of the previous flexible disk drive when the guide member 50 is used. When the threaded holes are reduced in number, the main printed circuit board 30A is increased in strength. Similarly, the main frame 13A is increased in strength when the supporting pieces are reduced in number.

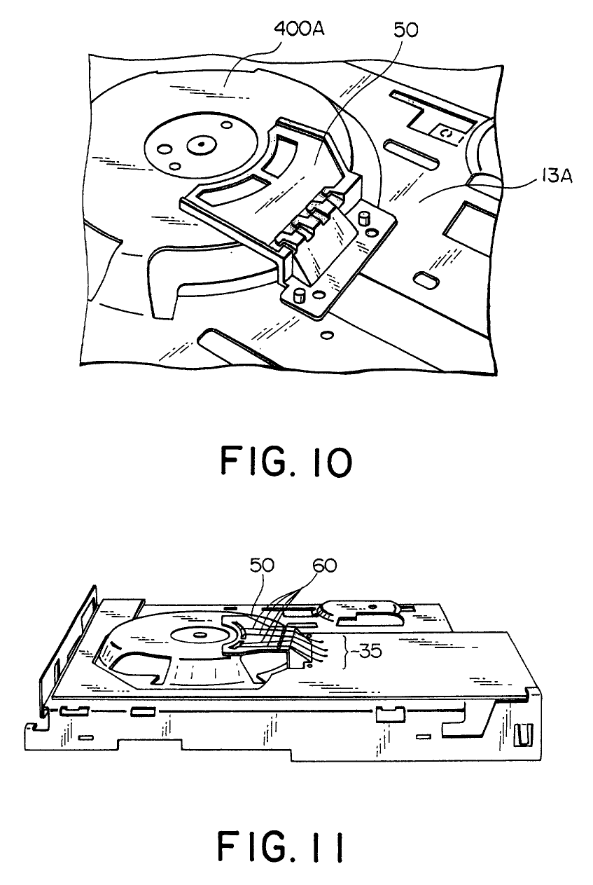

The guide member 50 is attached and fixed to the main frame 13A by inserting the protruding frame 54 and the engaging pins 55 of the first part 51 into the opening window 420 and through holes 430, respectively. The state where the guide member is attached to the main frame is illustrated in FIG. 10. Inasmuch as the protruding frame 54 is inserted in the opening window 420, the leads drawn out through the opening window 420 touch the protruding frame 54 instead of the opening windows 420.

Moreover, the guide member 50 is attached and fixed to the main printed circuit board 30A by fixing the main printed circuit board 30A to the main frame 13A so that the engaging pins 58 of the second part 52 are inserted in the through holes 34 formed in the main printed circuit board 30A. In consequence, the guide member 50 is partially disposed or inserted between the main frame 13A and the main printed circuit board 30A. The state where the guide member 50 is attached to both of the main frame 13A and the main printed circuit board 30A is illustrated in FIG. 11.

Thus, the guide member 50 is disposed between the leads and the main frame 13A from opening window 420 to the main printed board 30A.

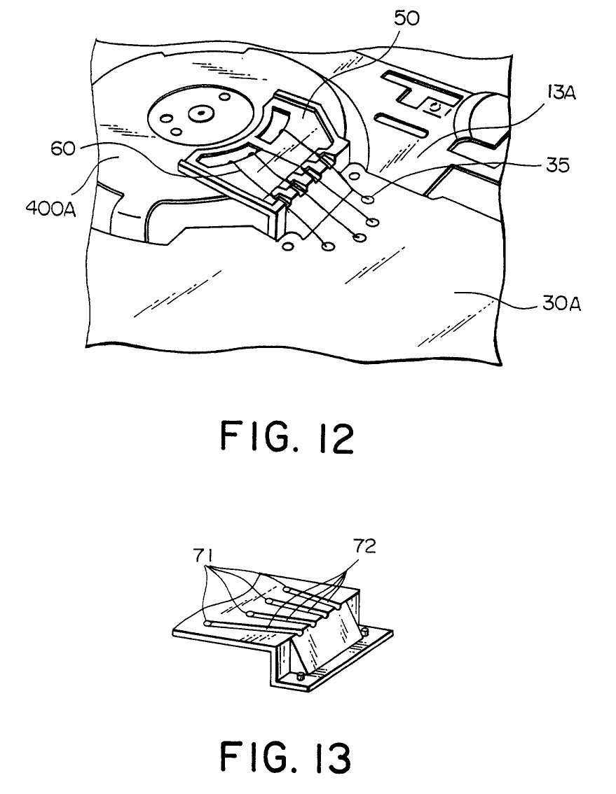

As illustrated in FIG. 12, the leads 60 are drawn out through the opening window 420. Then the leads 60 are hooked or hitched and fixed to the hooks 56, respectively. The hooks 56 prevent the leads 60 from touching one another. The ends of the leads 60 are connected and fixed to the predetermined terminals 35 formed on the main printed circuit board 30A.

As easily understood from the foregoing description, the guide member 50 prevents the leads 60 from touching an edge of the opening window 420 and/or one another and prevents coating of the leads 60 from being scraped off by the edge of the opening window 420 and/or by one another when the leads are connected to the terminals 35. As a result, occurrence of a short circuit between the leads and the main frame 13A and/or between the leads one another is prevented by the guide member 50. In addition, the guide member 50 guides each of the leads to the right one of the terminals 35 so as to avoid connection with wrong one of the terminals 35.

While this invention has thus far been described in conjunction with the preferred embodiment thereof, it is to be understood that modifications will readily be made by those skilled in the art without departing from the sprit of the invention. For example, as shown in FIG. 13, through holes 71 may be formed in the first part 51 to draw out the leads individually. In addition, grooves 72 may be formed on the reverse side of the first part 51 to guide the leads from the through holes 71 to the main printed circuit board 30A and to prevent the leads from touching one another. Furthermore, the through holes 71 may be combined with the hooks 56.

What is claimed is:

1. A flexible disk drive including a main frame having a main surface, a back surface, and an opening formed therein, a motor having a plurality of leads and mounted on said main surface, and a circuit board attached to said back surface, said leads being connected to said circuit board through said opening, said flexible disk drive comprising:
a guide member disposed between said main frame and said leads to extend from said opening to said circuit board so as to prevent said leads from touching said main frame.

2. A flexible disk drive as claimed in claim 1, wherein said guide member is made of an insulator.

3. A flexible disk drive as claimed in claim 1, wherein said guide member has hooks and/or grooves to prevent said leads from touching one another.

4. A flexible disk drive as claimed in claim 1, wherein said guide member is partially inserted between said main frame and said circuit board to support said circuit board against said main frame.

5. A flexible disk drive as claimed in claim 1, wherein said main frame has a protruding area which protrudes from said back surface and which has a top surface;
said opening being formed in said top surface;
said circuit board being disposed so as to avoid said protruding area and to be closer to said back surface than said top surface;
said guide member being disposed from said opening to an area between said main frame and said circuit board.

6. A wiring structure for arranging a plurality of leads from a first surface of a first member to a second surface of a second member having a third surface reverse to said second surface, said first and said second surfaces being substantially parallel to each other in a predetermined direction perpendicular to said first and said second surfaces and being arranged at different heights to form steps, said wiring structure comprising:
a guide member having a first portion fixed to said first surface, a second portion fixed to said third surface, and a third portion connecting said first portion with said second portion, said guide member being for guiding said leads.

7. A wiring structure as claimed in claim 6, wherein said guide member is made of an insulator.

8. A wiring structure as claimed in claim 6, wherein said guide member further has a plurality of hooks for hooking said leads, individually.

9. A wiring structure as claimed in caim 6, said first member having a first hole formed in said first surface, said second member having a second hole formed in said third surface, said guide member having a first projection corresponding to said first hole on said first portion and a second projection corresponding to said second hole on said second portion, wherein said guide member fixed to said first and said second surfaces by inserting said first and said second projections into said first and said second holes, respectively.

10. A wiring structure as claimed in claim 6, said first member having a fourth surface opposite to said third surface with a space left therebetween, wherein said guide member further has a supporting projection formed on said second portion for supporting said second member against said fourth surface.

11. A wiring structure as claimed in claim 6, wherein both said second surface and said fourth surface are lower than said first surface when first surface faces upward.

12. A guide member for guiding a plurality of leads from a first surface of a first member to a second surface of a second member having a third surface reverse to said second surface, said first and said second surfaces being substantially parallel to each other in a predetermined direction perpendicular to said first and said second surfaces and being arranged at different heights to form steps, said guide member comprising:
a first portion fixed to said first surface,
a second portion fixed to said third surface, and
a third portion connecting said first portion with said second portion.

13. A guide member as claimed in claim 12, wherein said guide member further comprises a plurality of hooks for hooking said leads, individually.

14. A guide member as claimed in claim 12, wherein said guide member is made of an insulator.

15. A guide member as claimed in claim 12, said first member having a first hole formed in said first surface, said second member having a second hole formed in said third surface, wherein said guide member further comprises:
a first projection formed on said first portion to be inserted into said first hole, and
a second projection formed on said second portion to be inserted into said second hole.

16. A guide member as claimed in claim 12, said first member having a fourth surface opposite to said third surface with a space left therebetween, wherein said guide member further comprises a supporting projection formed on said second portion to support said second member against said fourth surface.

17. A guide member as claimed in claim 12, wherein said guide member is used in a flexible disk drive.
